(19) United States
(12) Patent Application Publication
(10) Pub. No.: US 2009/0103004 A1
(43) Pub. Date: Apr. 23, 2009

(54) BACKLIGHT MODULE AND LIGHT GUIDE PLATE

(75) Inventors: Ming-Hsien Su, Hsinchu (TW); Kuo-Ming Thank, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsinchu (TW)

(21) Appl. No.: 12/016,259

(22) Filed: Jan. 18, 2008

(30) Foreign Application Priority Data
Oct. 22, 2007 (TW) 96139451

(51) Int. Cl. G02F 1/1335

(52) U.S. Cl. 349/62; 349/64

(57) ABSTRACT

A backlight module includes a frame, a light guide plate, a light source, a reflective film, a diffusion film and a prism film. The light guide plate includes a first side, a second side, a hook, a light-emitting surface, a top side, and a bottom side. The first side is adjacent to the second side. The hook connects to the first side and engages the frame. The light-emitting surface is adjacent to the first and second sides and formed with a plurality of v-shaped grooves and a flat portion. The flat portion corresponds to the hook and abuts part of the v-shaped grooves. The light source is disposed on the second side. The reflective film is disposed on the bottom side. The prism film and the diffusion film are disposed on the top side. The frame accommodates the above-mentioned components.

### BACKGROUND OF THE INVENTION

1. Field of the Invention

The invention relates to a backlight module, and more particularly to a backlight module effectively preventing formation of bright lines.

2. Description of the Related Art

A backlight module usually includes a frame, a light guide plate, multiple light sources, a reflective film, a diffusion film, and multiple prism films. The light sources, such as LEDs, may be disposed on one side of the light guide plate. Multiple concave patterns may be formed on a bottom surface of the light guide plate. When the light sources emit light into the light guide plate, the concave patterns formed on the bottom surface thereof destroy total reflection of the light. Accordingly, most of the light leaves the light guide plate through a top surface (light-emitting surface) thereof, enabling the light guide plate or backlight module to present required luminance.

In another aspect, to reduce the weight and thickness of the backlight module, the thickness of the light guide plate must be reduced. Here, the overall strength of the light guide plate deteriorates due to the reduced thickness thereof, such that attachment between the light guide plate and the frame is adversely affected. Multiple hooks must be additionally disposed on two lateral sides of the light guide plate. By engaging the hooks in the frame, the light guide plate is securely disposed in the backlight module.

Moreover, to enable the light guide plate to present higher luminance, in addition to the concave patterns formed on the bottom surface thereof, multiple miniature v-shaped grooves are formed on the top surface thereof. Accordingly, the light transmitted in the light guide plate further completely transmits out through the top surface (light-emitting surface) thereof.

Referring to FIG. 1, a conventional backlight module includes a light guide plate 10 and a plurality of light sources 20.

The light guide plate 10 includes two opposite first sides 11, a second side 12, a plurality of hooks 13, a light-emitting surface (top surface) 14, and a bottom surface (not shown).

The first sides 11 are connected to the second side 12. Namely, the second side 12 is connected between the first sides 11.

The hooks 13 are respectively connected to the first sides 11. Specifically, each of the hooks 13 includes a first end surface 13a and a second end surface 13b. The first end surface 13a is opposite the second end surface 13b and between the second side 12 and the second end surface 13b.

The light-emitting surface 14 is connected to the first sides 11 and the second side 12 and formed with a plurality of v-shaped grooves 14a.

The bottom surface is opposite the light-emitting surface 14 and formed with a plurality of concave patterns (not shown).

The light sources 20 are disposed on the second side 12 of the light guide plate 10.

When light from the light sources 20 enters the light guide plate 10, the v-shaped grooves 14a formed on the light-emitting surface 14 and the concave patterns formed on the bottom surface destroy total reflection of the light. Accordingly, most of the light transmits out of the light guide plate 10 through the light-emitting surface 14 thereof, enabling the light guide plate 10 or backlight module to present high luminance. Nevertheless, when the light from the light sources 20 illuminates the second end surfaces 13b of the hooks 13 via the light guide plate 10, reflected light from the second end surfaces 13b is further reflected by the v-shaped grooves 14a, thus forming a plurality of bright lines S, corresponding to and extending from the second end surfaces 13b, on the light-emitting surface 14 of the light guide plate 10. The length of the bright lines S increases when the distance between the hooks 13 and the light sources 20 (or second side 12) reduces. Specifically, the bright lines S adversely affect optical output of the light guide plate 10 or backlight module. Moreover, even though the disposition or size or angle of the hooks 13 is changed, the bright lines S still exist on the light-emitting surface 14. Additionally, although prism films (not shown), covering the light guide plate 10, weakens the bright lines S, the bright lines S are not completely eliminated thereby.

Hence, there is a need for a backlight module presenting high luminance, effectively preventing formation of bright lines, and providing enhanced quality of optical output.

### BRIEF SUMMARY OF THE INVENTION

The present invention is to provide a backlight light, which not only presents high luminance, but also prevents formation of bright lines so as to provide enhanced quality of optical output.

An exemplary embodiment of the invention provides a backlight module comprising a light guide plate, at least one light source, a reflective film, at least one prism film, a diffusion film, and a frame. The light guide plate includes a first side, a second side, at least one hook, and a light-emitting surface. The first side is adjacent to the second side. The hook is connected to the first side. The light-emitting surface is adjacent to the first and second sides and formed with a plurality of v-shaped grooves and at least one flat portion. The flat portion is disposed corresponding to the hook and abuts part of the v-shaped grooves. The light source is disposed on the second side of the light guide plate. The reflective film is disposed on a bottom side of the light guide plate. The prism film is disposed on a top side of the light guide plate. The diffusion film is disposed on the top side of the light guide plate and between the light guide plate and the prism film. The frame accommodates the light guide plate, light source, reflective film, prism film, and diffusion film for forming the backlight module. The light guide plate is engaged with the frame by the hook.

Since the plat portion corresponds to the hook, the light reflected from the second end surface of the hook is not further reflected by the v-shaped grooves when the light from the light source illuminates the hook via the light guide plate. Thus, no bright line is formed. Accordingly, in additional to presenting high luminance, the light guide plate or backlight module simultaneously provides enhanced quality of optical output.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1 is a schematic partial plane view of a conventional backlight module;

FIG. 2 is a schematic partial cross section and side view of a backlight module of an embodiment of the invention;

FIG. 3 is a schematic top view of a light guide plate and light sources of a backlight module of an embodiment of the invention; and

FIG. 4 is a partial enlarged view of FIG. 3.

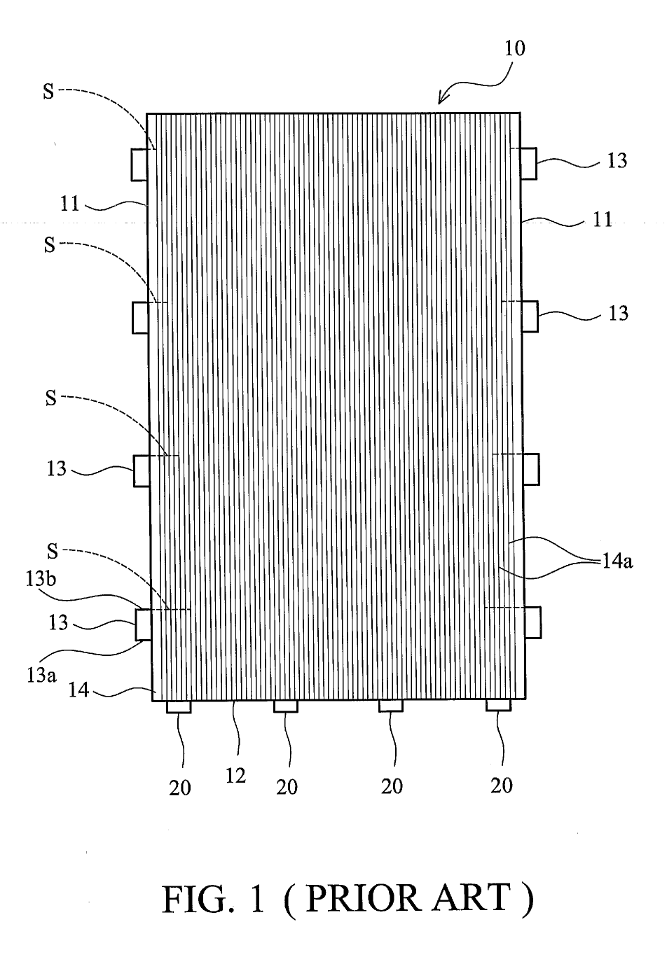

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

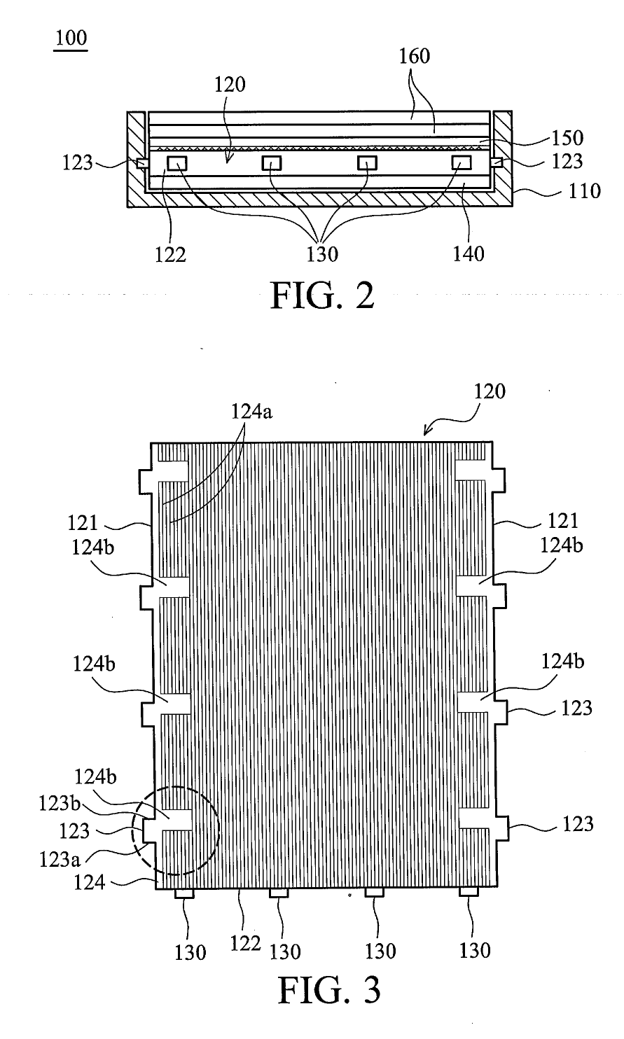

Referring to FIG. 2, a backlight module 100 according to an embodiment of the present invention includes a frame 110, a light guide plate 120, a plurality of light sources 130, a reflective film 140, a diffusion film 150, and a plurality of prism films 160. The frame 110 accommodates the light guide plate 120, light sources 130, reflective film 140, diffusion film 150, and prism films 160 therein for forming the backlight module 100. The reflective film 140 is disposed on a bottom side of the light guide plate 120. The prism films 160 are disposed on a top side of the light guide plate 120. The diffusion film 150 is disposed on the top side of the light guide plate 120 and between the light guide plate 120 and the prism films 160.

Referring to FIG. 3, the light guide plate 120 includes two opposite first sides 121, a second side 122, a plurality of hooks 123, and a light-emitting surface 124.

The first sides 121 are adjacent to the second side 122. Specifically, the second side 122 is connected between the first sides 121.

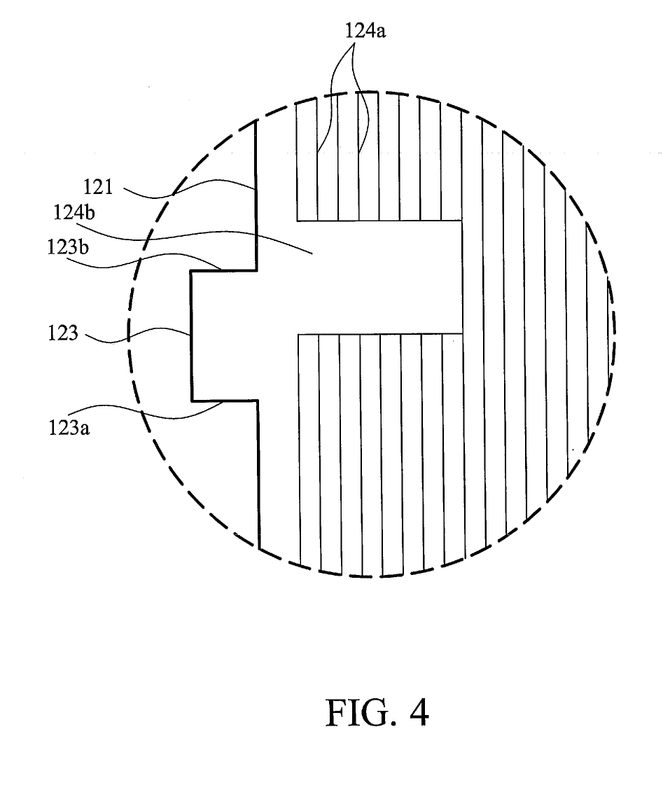

As shown in FIG. 2 and FIG. 3, the hooks 123 are connected to the two first sides 121 and engaged in the frame 110, respectively. Specifically, as shown in FIG. 3 and FIG. 4, each of the hooks 123 includes a first end surface 123a and a second end surface 123b. In this embodiment, for each of the hooks 123, the first end surface 123a is opposite to the second end surface 123b, and is closer to the second side 122 than the second end surface 123b.

As shown in FIG. 3, the light-emitting surface 124 is adjacent to the first sides 121 and second side 122. In this embodiment, the light-emitting surface 124 is a top surface (or top side) of the light guide plate 120. Additionally, the light-emitting surface 124 is formed with a plurality of v-shaped grooves 124a and a plurality of flat portions 124b. Each of the flat portions 124b is disposed corresponding to each hook 123 and abuts part of the v-shaped grooves 124a. Specifically, as shown in FIG. 3 and FIG. 4, each of the flat portions 124b corresponds to the second end surface 123b of each hook 123. In this embodiment, each of the flat portions 124b is substantially rectangular and located at an extending line of the second end surface 123b of each hook 123 on the light-emitting surface 124. Moreover, each flat portion 124b is not limited to being rectangular. Namely, each flat portion 124b may be provided with other profiles.

As shown in FIG. 2 and FIG. 3, the light sources 130 are disposed on the second side 122 of the light guide plate 120. Here, the light sources 130 may be LEDs, laser LEDs, or CCFLs.

Moreover, multiple concave patterns (not shown) are formed on a bottom surface (i.e. the bottom side or a surface opposite the light-emitting surface 124) of the light guide plate 120.

When light from the light sources 130 enters the light guide plate 120, the v-shaped grooves 124a formed on the light-emitting surface 124 and the concave patterns formed on the bottom surface destroy total reflection of the light. Accordingly, most of the light transmits out of the light guide plate 120 through the light-emitting surface 124 thereof, enabling the light guide plate 120 or backlight module 100 to present high luminance. Here, as each of the flat portions 124b corresponds to (the second end surface 123b of) each hook 123, light reflected from (the second end surface 123b of) each hook 123 is not further reflected by the v-shaped grooves 124a when the light from the light sources 130 illuminates (the second end surface 123b of) each hook 123 via the light guide plate 120. Thus, no bright line is formed. Accordingly, in additional to presenting high luminance, the light guide plate 120 or backlight module 100 simultaneously provides enhanced quality of optical output.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light guide plate comprising a first side, a second side, at least one hook, and a light-emitting surface, wherein the first side is adjacent to the second side, the hook is connected to the first side, the light-emitting surface is adjacent to the first and second sides and formed with a plurality of v-shaped grooves and at least one flat portion, and the flat portion is disposed corresponding to the hook and abuts part of the v-shaped grooves;
at least one light source, disposed on the second side of the light guide plate;
a reflective film, disposed on a bottom side of the light guide plate;
at least one prism film, disposed on a top side of the light guide plate;
a diffusion film, disposed on the top side of the light guide plate and between the light guide plate and the prism film; and
a frame, accommodating the light guide plate, the light source, the reflective film, the prism film, and the diffusion film for forming the backlight module, wherein the light guide plate is engaged with the frame by the hook.

2. The backlight module as claimed in claim 1, wherein the hook comprises a first end surface and a second end surface opposite to the first end surface, the first end surface is closer to the second side than the second end surface, and the flat portion of the light-emitting surface corresponds to the second end surface.

3. The backlight module as claimed in claim 2, wherein the flat portion of the light-emitting surface is located at an extending line of the second end surface of the hook on the light-emitting surface.

4. The backlight module as claimed in claim 1, wherein the flat portion of the light-emitting surface is substantially rectangular.

5. The backlight module as claimed in claim 1, wherein the v-shaped grooves are formed on the light-emitting surface of the light guide plate.

6. A light guide plate for a backlight module, comprising:
a first side;
at least one hook connected to the first side; and
a light-emitting surface adjacent to the first side and formed with a plurality of v-shaped grooves and at least one flat portion, wherein the flat portion is disposed corresponding to the hook and abuts part of the v-shaped grooves.

7. The light guide plate as claimed in claim 6, wherein the hook comprises a first end surface and a second end surface opposite to the first end surface, and the flat portion of the light-emitting surface corresponds to the second end surface.

8. The light guide plate as claimed in claim 7, wherein the flat portion of the light-emitting surface is located at an extending line of the second end surface of the hook on the light-emitting surface.

9. The light guide plate as claimed in claim 6, wherein the flat portion of the light-emitting surface is substantially rectangular.
